(19) United States
(12) Patent Application Publication
(10) Pub. No.: US 2004/0001742 A1
(43) Pub. Date: Jan. 1, 2004

(54) Machine tool comprising a braking apparatus for a machine part

(76) Inventor: Armin Bornemann, Marktoberdorf (DE)

Correspondence Address: THE MAXHAM FIRM, 750 "B" STREET, SUITE 3100, SAN DIEGO, CA, 92101, US

(21) Appl. No.: 10/376,370

(22) Filed: Feb. 28, 2003

(30) Foreign Application Priority Data
Mar. 5, 2002 (DE) 202 03 501.8

(51) Int. Cl. B23C 1/00

(52) U.S. Cl. 409/131; 409/241

(57) ABSTRACT

A machine tool having at least one motor-driven, movable machine part to which a braking apparatus, a distance measuring device for detecting a distance covered, as well as control device with display unit are allocated. A monitoring device for the brake effect of the braking apparatus is provided. The monitoring device has a memory unit containing stored values (RW, VW and AW) and a comparator. A deterioration of the brake effect is detected by comparing the braking distances detected by the distance-measuring device with the values stored in the memory unit, the display being activated if required.

### BACKROUND OF THE INVENTION

1. Field of the Invention

The present invention relates generally to machine tools, and more specifically to machine tools having at least one motor-driven, movable machine part to which a braking apparatus, a distance measuring device, as well as a control unit with a display, are provided.

2. Discussion of Related Art

Motor-driven, movable machine parts include vertically movable panels and slides as carriers of workpiece tables and spindle heads. These machine parts may weigh several tons. The drive systems for these machine parts are provided with an operational brake, usually in the form of a “motor brake.” In modem machine tools additional safety brakes are provided, automatically reacting during maintenance or repair work, to prevent spontaneous slipping of the heavy, vertically movable machine parts and to eliminate danger while the operational brake is turned off. As mentioned, these safety brakes are in addition to the operational brakes.

In currently known brake systems, the functionality of the operational brakes and the safety brakes cannot be determined from the outside. This imposes considerable danger and risk. Thus, particularly during initialization, maintenance and inspection, the non-foreseeable failure of the safety brake may lead to a sudden slipping or falling of the machine part. In case of horizontally movable machine parts, an override of the predetermined distances caused by a failure of the associated brake may result in collision and damage.

### SUMMARY OF THE INVENTION

It is a purpose of the present invention to provide a machine tool in which the functionality of the braking apparatus for the movable machine parts may be detected and communicated to the user in a simple and effective way.

According to the invention, this object is achieved by having a monitoring device for the brake effect of the respective braking apparatus. The monitoring apparatus includes a memory unit that contains stored reference values and a comparator for detecting a deterioration of the braking effect. This is achieved by comparing a stored reference value with the measured values from the distance measuring device and activates a display.

With respect to safety, an important aspect of the invention is the automatic monitoring of the brakes of the vertically movable machine parts by a pre-selected response of the machine control. From the construction data of a new machine, it is known what distance a movable machine part will move after the associated brake has been activated, for example, by operating the emergency stop button, by opening the cabin door, or by releasing the permissive button. That distance (the braking distance) is generally only about a few 1/100 mm long and is stored as a reference value in the memory unit of the monitoring device. During each braking operation, the distance covered by the machine part after the activation of the brake is detected as an actual value by the distance measuring device and compared with the reference value in the comparator. If the reference value is exceeded by a predetermined and stored amount, the monitoring device outputs an optical or acoustic early indication or warning signal. This informs the user of an already advanced wear of the brake, that is, a certain degradation of the braking effect. This indication may, for example, also be used to determine when the next inspection is due.

If the braking distance measured during a braking operation further increases and reaches or exceeds a threshold value (the threshold value being stored in the memory after continued machine operation and repeated braking), the program control deactivates the machine. This preferably occurs in combination with a simultaneous activation of the optical or acoustic indication.

Even though the monitoring of the functionality of the brakes is designed under safety aspects for the safety brakes of vertically or transversely movable machine parts having a relatively large mass, the invention also contemplates an analogous monitoring of the braking apparatus of horizontally movable machine components. These can be movable columns, slides, workpiece tables, or the like. In these cases, the invention prevents an override of the distances due to brake wear, where the distances are predetermined by the program or set manually.

Since a reliable demobilization of vertically movable components cannot be granted by their motor brake alone, under certain conditions separate safety brakes are provided on the machine parts under safety aspects to eliminate any risk. The monitoring system according to the invention is independent of the functionality of the one or the other brake type, since it is based on the distance measurement and the respective reference values or distances. Since a single error in the one or the other braking apparatus may not lead to the loss of the safety function, the monitoring system according to the invention is redundant and indicates the ultimately decisive overall effectiveness of the brake systems involved.

### BRIEF DESCRIPTION OF THE DRAWING

Further particularities and advantages of the invention will become clear from the following description of preferred embodiments with reference to the drawing, in which:

FIG. 1 is a perspective view of one embodiment of the machine tool according to the present invention; and

FIG. 2 is a flow diagram of the steps carried out during a brake monitoring operation.

### DETAILED DESCRIPTION OF THE PREFERRED EMBODIMENTS

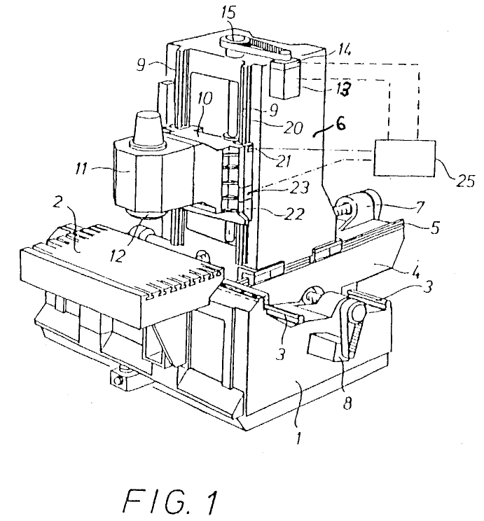

The basic milling machine shown in FIG. 1 is intended for illustrating the invention herein. The machine comprises transverse bed 1 sloping rearwardly, and on the front side of which is mounted workpiece table 2. Slide 4 is movably mounted on parallel guide rails 3 in the direction of a first coordinate axis and is supported on the transverse bed. Column 6 is movable along a second horizontal coordinate axis on guide rails 5 of slide 4. The drives for the movements of slide 4 and column 6 are electric motors 7 and 8, which include integrated operational brakes connected to spindle drives via V-belts. Panel 10, carrying spindle head 11 with integrated work spindle 12, is movable along the vertical coordinate axis on front guide rails 9 of column 6. Electric motor 13, including integrated operational brake 14, is mounted on column 6 as a drive for the vertical movements of the spindle head. Motor 13 is connected to vertical spindle drive 15 via a V-belt, for example.

Distance measuring device, comprising a linear scale and a reading head connected to NC controller 25 of the machine, are allocated to each of the machine parts movable along the respective coordinate axes. FIG. 1 schematically shows only linear scale 20 and corresponding reading unit 21, which reading unit is mounted to panel 10. In each of two guiding elements 22 of panel 10, which interact with guide rails 9, safety brake 23 is provided which is also connected to NC controller 25. Monitoring device for the brake effect of brakes 14 and 23, comprises a memory for certain brake data and a comparator for comparing the braking distances detected by the distance measuring means 20 and 21 with the reference values stored in the memory, are integrated in NC controller 25. The function of the monitoring device will now be described.

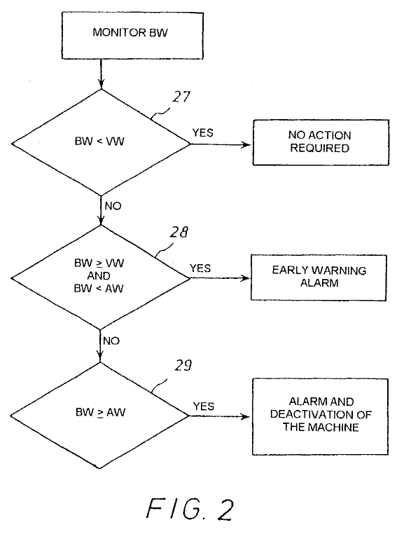

The observation of the brake effect is carried out by the following steps shown in FIG. 2. Before the initial activation of the machine tool, or possibly after driving or braking functions have occurred, a reference value, RW, is determined and stored for all brakes in the normal state by authorised personnel. The RW is composed of a response delay, dt, and a brake value, d_{tB}. The response delay, dt, represents the period between the deactivation of the drive, or the simultaneous activation of the associated brake, and the response of the brake or the distance the machine part has moved within this period. The brake value, dtB, is the value from the response of the brake to the standstill of the stopped machine part. An early warning value, VW, which exceeds RW by a predetermined amount, as well as a turn-off value, AB, which is again greater than the early warning value, VW, are stored in the memory simultaneously or automatically.

During each following braking operation the monitoring device according to the invention shown in FIG. 2 is activated. In first step 27, the brake distance BW detected by the distance measuring device, consisting of dt and d_{tB}, is compared with the early warning value, VW, in the memory unit. As long as BW<VW holds true, there will be no reaction, that is, the machine and the respective brake are in their normal operating state. If the brake distance, BW, reaches or exceeds the early warning value, VW, but remains below the turn-off value, AW, an early warning message is issued in step 28 by activating the optical or acoustic indication, thereby informing the operator of an advanced wear or other, not yet critical, malfunction of the brake. This allows corresponding measures to be taken. In step 29 it is determined whether the brake distance, BW, reached or exceeds the turn-off value, AW, stored in the memory. If this is the case, the machine is turned off and a corresponding alarm is produced.

While the present invention has been illustrated and described by means of specific embodiments, it is to be understood that numerous changes and modifications can be made therein without departing from the spirit and scope of the invention. Accordingly, the invention is limited only by the claims.

What is claimed is:

1. A machine tool comprising:
at least one motor-driven, movable machine part having brake means, distance measuring means for detecting a distance moved, and control means including display means; and
monitoring means for the brake effect of the brake means, said brake means comprising:
memory means containing stored values; and
a comparator;
the monitoring means providing detection of a deterioration of the brake effect by comparing the braking distances detected by the distance measuring means with the values stored in the memory means, the display means being selectively activated.

2. The machine tool of claim 1, wherein a reference value (RW), an early warning value (VW), and a turn-off value (AW) are stored in the memory means.

3. A method of determining the functionality of a braking apparatus of movable parts in a machine tool, said method comprising:
moving at least one motor-driven, movable machine part, said part having brake means, distance measuring means, and control means including display means;
applying the brake means, the brake means comprising:
memory means containing stored values; and
a comparator;
using the distance measuring means to measure the distance the machine part moved during the brake application;
comparing the braking distances detected by the distance measuring means with the values stored in the memory means; and
activating the display means;
wherein if the braking distance measured is greater than the values stored in the memory means, a warning is indicated by the display means, thereby providing an indication of the functionality of the braking apparatus of movable parts in the machine tool.
